(19) United States
(12) Patent Application Publication
(10) Pub. No.: US 2026/0208121 A1
(43) Pub. Date: Jul. 23, 2026

(54) MXene MEMBRANE WITH GRADIENT PORES, PREPARATION METHOD AND APPLICATION THEREOF

(71) Applicant: South China University Of Technology, Guangzhou City (CN)

(72) Inventors: Yanying WEI, Guangzhou City (CN); Yufei WANG, Guangzhou City (CN); Libo LI, Guangzhou City (CN); Mide LUO, Guangzhou City (CN); Zong LU, Guangzhou City (CN)

(73) Assignee: South China University Of Technology, Guangzhou City (CN)

(21) Appl. No.: 19/423,223

(22) Filed: Dec. 17, 2025

(30) Foreign Application Priority Data
Jan. 23, 2025 (CN) 202510107120.X

(51) Int. Cl. B01D 69/02; B01D 53/22; B01D 67/00; B01D 69/12; B01D 71/02

(52) U.S. Cl. CPC B01D 69/02; B01D 53/228; B01D 67/0046; B01D 67/006; B01D 69/12; B01D 71/02; B01D 2323/081; B01D 2323/34; B01D 2325/02831; B01D 2325/02832; B01D 2325/04

(57) ABSTRACT

A MXene membrane with gradient pores, its preparation method and application are provided. The MXene membrane with gradient pores, excluding the substrate, includes the following layers in sequence from bottom to top: an ultra large pore MXene membrane layer with a thickness of 0-30 nanometers (nm) and a pore size of 2-5 nm; a large pore MXene membrane layer with a thickness of 0-30 nm and a pore size of 0.9-1.2 nm; a medium pore MXene membrane layer with a thickness of 20-50 nm and a pore size of 0.6-0.8 nm; and a small pore MXene membrane layer with a thickness of 40-60 nm and a pore size of 0.3-0.5 nm. The present disclosure prepares the MXene membrane with gradient pores by repeating spin-coating and plasma irradiation while limiting the irradiation time.

### CROSS-REFERENCE TO RELATED APPLICATIONS

This application claims priority to Chinese Patent Application No. 202510107120.X, filed on Jan. 23, 2025, the contents of which are hereby incorporated by reference.

### TECHNICAL FIELD

The present disclosure belongs to the technical field of separation membrane materials, and particularly relates to a MXene membrane with gradient pores, a preparation method and an application thereof.

### BACKGROUND

In recent years, two-dimensional (2D) nanosheets have been widely used as membrane building blocks for gas and ion separation due to their atomic thickness. The 2D membranes assembled therefrom overcome the trade-off between permeability and selectivity inherent in conventional polymer membranes. MXene (Ti₃C₂Tₓ), as a type of two-dimensional transition metal carbide, has been extensively used in the fabrication of membrane materials. Its laminated membranes show great potential in gas and ion sieving, and even broader application prospects in the future. MXene nanosheets are in-plane non-porous; therefore, the interlayer channels between adjacent MXene nanosheets dominate the gas transport within MXene membranes. However, the single type of interlayer channel results in long and tortuous gas diffusion pathways, leading to a relatively low permeation rate of MXene membranes. Consequently, introducing artificial in-plane pores onto the 2D non-porous nanosheets is an effective strategy to shorten the mass transfer pathways and enhance the separation performance of laminated membranes.

However, existing pore-creating methods (such as copper ion (Cu²⁺)/oxygen (O₂), sulfuric acid (H₂SO₄), and hydrogen peroxide (H₂O₂) etching) typically involve the introduction of chemical substances, and the created pores are generally of nanometer size. Pores of nanometer size are relatively large for sieving small gas molecules with a kinetic diameter of only 2-4 Ångströms, which may sacrifice membrane selectivity to some extent. If Ångström-sized pores could be fabricated on MXene nanosheets, it would be promising to achieve more efficient gas separation by MXene membranes. Furthermore, a single pore-creating condition leads to MXene membranes with a uniform pore size: either the pores are too large, resulting in high permeability but low selectivity; or the pores are too small, resulting in low permeability but high selectivity. That is, permeability and selectivity may not be reconciled.

Therefore, there is an urgent need to develop a novel porous MXene membrane capable of achieving both high permeability and high selectivity simultaneously.

### SUMMARY

To address the aforementioned technical problems, the present disclosure proposes a MXene membrane with gradient pores, its preparation method and application.

To achieve the above objective, the present disclosure provides the following technical schemes.

A first technical scheme of the present disclosure is:
a MXene membrane with gradient pores, excluding the substrate, includes following layers in sequence from bottom to top:
an ultra large pore MXene membrane layer with a thickness of 0-30 nanometers (nm) and a pore size of 2-5 nm;
a large pore MXene membrane layer with a thickness of 0-30 nm and a pore size of 0.9-1.2 nm;
a medium pore MXene membrane layer with a thickness of 20-50 nm and a pore size of 0.6-0.8 nm; and
a small pore MXene membrane layer with a thickness of 40-60 nm and a pore size of 0.3-0.5 nm;
where the overall thickness of the MXene membrane layers is 100 nm.

Optionally, the MXene membrane with gradient pores, excluding the substrate, includes the following layers in sequence from bottom to top:
a large pore MXene membrane layer with a thickness of 30 nm and a pore size of 0.9-1.2 nm;
a medium pore MXene membrane layer with a thickness of 30 nm and a pore size of 0.6-0.8 nm; and
a small pore MXene membrane layer with a thickness of 40 nm and a pore size of 0.3-0.5 nm.

Optionally, the MXene membrane with gradient pores, excluding the substrate, includes the following layers in sequence from bottom to top:
a large pore MXene membrane layer with a thickness of 10 nm and a pore size of 0.9-1.2 nm;
a medium pore MXene membrane layer with a thickness of 30 nm and a pore size of 0.6-0.8 nm; and
a small pore MXene membrane layer with a thickness of 60 nm and a pore size of 0.3-0.5 nm.

Optionally, the MXene membrane with gradient pores, excluding the substrate, includes the following layers in sequence from bottom to top:
a medium pore MXene membrane layer with a thickness of 50 nm and a pore size of 0.6-0.8 nm; and
a small pore MXene membrane layer with a thickness of 50 nm and a pore size of 0.3-0.5 nm.
In an embodiment, the MXene is Ti₃C₂Tₓ; where Tₓ represents surface functional groups (such as Hydroxyl (—OH), Oxo (═O), and Oxo (—F), etc.).

In an embodiment, the material of the substrate is at least one selected from polyethersulfone, nylon, polyvinylidene fluoride, cellulose acetate, polyacrylonitrile, or polysulfone.

A second technical scheme of the present disclosure is:
a preparation method for a MXene membrane with gradient pores, including the following steps:
spin-coating MXene nanosheet dispersion onto a substrate, drying, followed by plasma irradiation, and repeating the above operation, where the MXene membrane with gradient pores is obtained by controlling the plasma irradiation time.

Optionally, the concentration of MXene nanosheets in the MXene nanosheet dispersion is 0.5 milligram per milliliter (mg/mL); the solvent in the dispersion is ethanol and water, with a volume ratio of ethanol to water being 0.5-1:1.

Optionally, the drying process is: vacuum drying at 100 degrees Celsius (C) for 30 minutes (min).

Optionally, the conditions during the plasma irradiation are:
an irradiation power: 100 Watt (W); a gas flow rate: 100 milliliters per minute (mL/min); and an irradiation time: 2-15 min.

In an embodiment, the plasma gas used for the plasma irradiation is Argon (Ar).

In an embodiment, when the irradiation time is 11-15 min, an ultra large pore MXene membrane layer is formed;
when the irradiation time is 6-10 min, a large pore MXene membrane layer is formed;
when the irradiation time is 3-5 min, a medium pore MXene membrane layer is formed; and
when the irradiation time is 1-2 min, a small pore MXene membrane layer is formed.

In an embodiment, when the irradiation time is 15 min, an ultra large pore layer is formed;
when the irradiation time is 10 min, a large pore MXene membrane layer is formed;
when the irradiation time is 5 min, a medium pore MXene membrane layer is formed; and
when the irradiation time is 2 min, a small pore MXene membrane layer is formed.

A third technical scheme of the present disclosure is:
an application of the aforementioned MXene membrane with gradient pores in gas separation.

Optionally, the gas separation is hydrogen (H₂)/carbon dioxide (CO₂) gas separation.

Optionally, the MXene membrane with gradient pores has an H₂ permeation rate of 980-1600 Gas Permeation Unit (GPU); and an H₂/CO₂ selectivity of 160-180.

Compared with the prior art, the present disclosure has the following advantages and technical effects.

The pore-creating and membrane-forming process adopted in the preparation method disclosed in the present disclosure is simple and controllable. The MXene membrane with gradient pores may be prepared by the strategy of repeating spin-coating+plasma irradiation.

Compared with MXene membranes with only a single type of interlayer channel, the MXene membrane prepared by the method of the present disclosure has a gradient pore structure, composed of small pore (0.3-0.5 nm), medium pore (0.6-0.8 nm), and large pore (0.9-1.2 nm) layers. The large pore layer of the MXene membrane may serve as a base support layer while also contributing to the permeability of the membrane. The vertical multi-Ångström channels in the small and medium pore layers, along with the effective interlayer channels, endow the MXene membrane with both an ultra-high H₂ permeation rate and excellent H₂/CO₂ selectivity.

### BRIEF DESCRIPTION OF THE DRAWINGS

The drawings forming a part of the present disclosure are provided to further understand the present disclosure. The schematic embodiments of the present disclosure and their descriptions are used to explain the present disclosure and do not constitute an improper limitation thereof. In the drawings:

FIG. 1 is a flow chart of preparing the MXene membrane with gradient pores according to Embodiment 1 of the present disclosure.

FIG. 2 is a Transmission Electron Micrograph (TEM) image of MXene nanosheets after different plasma irradiation times according to Embodiment 1 of the present disclosure.

### DETAILED DESCRIPTION OF THE EMBODIMENTS

Various exemplary embodiments of the present disclosure are now described in detail. This detailed description is required not to be construed as a limitation of the present disclosure, but rather be understood as a more detailed description of certain aspects, features, and embodiments of the present disclosure.

It is required not to be understood that the terms used herein are only for describing specific embodiments and are not intended to limit the present disclosure. In addition, for numerical ranges in the present disclosure, it is required not to be understood that each intermediate value between the upper and lower limits of the range is also specifically disclosed. Every smaller range between any stated value or intermediate value within a stated range and any other stated value or intermediate value within the range is also included in the present disclosure. The upper and lower limits of these smaller ranges may be independently included or excluded from the range.

Unless otherwise stated, all technical and scientific terms used herein have the same meaning as commonly understood by one of ordinary skill in the art to which this disclosure belongs. Although only optional methods and materials are described herein, any methods and materials similar or equivalent to those described herein may also be used in the practice or testing of the present disclosure. All documents mentioned in this specification are incorporated by reference to disclose and describe methods and/or materials related to the documents. In case of conflict with any incorporated document, the content of this specification shall prevail.

Various modifications and changes may be made to the specific embodiments of the specification of the present disclosure without departing from the scope or spirit of the present disclosure, which will be apparent to those skilled in the art. Other embodiments obtained from the specification of the present disclosure are obvious to those skilled in the art. The specification and embodiments of the present disclosure are exemplary only.

Regarding terms such as “comprising”, “including”, “having”, “containing” used herein, they are all open-ended terms, meaning inclusion but not limited to.

An embodiment of the present disclosure discloses a preparation method for a MXene membrane with gradient pores, including the following steps:
(1) a MXene nanosheet dispersion is spin-coated onto a porous substrate to load a MXene membrane with a certain thickness, then it is dried and subjected to long-time (11-15 minutes (min)) Argon (Ar) plasma irradiation. The above spin-coating and irradiation steps are repeated multiple times to obtain a MXene membrane with an ultra large pore MXene membrane layer;
(2) multiple spin-coating operations are performed on the MXene membrane with the ultra large pore layer obtained in step (1). After drying, long-time (6-10 min) Ar plasma irradiation is performed. The above spin-coating and irradiation steps are repeated multiple times to obtain a MXene membrane with a large pore MXene membrane layer;
(3) multiple spin-coating operations and medium-time (3-5 min) Ar plasma irradiation are performed on the MXene membrane with the large pore layer obtained in step (2) to obtain a MXene membrane with a medium pore MXene membrane layer; and
(4) on the basis of step (3), multiple spin-coating operations and short-time (1-2 min) Ar plasma irradiation are continued to obtain a MXene membrane with gradient pores (including ultra large pore, large pore, medium pore, and small pore MXene membrane layers).

The MXene membrane prepared by the above method has a gradient structure and, excluding the substrate, includes the following layers in sequence from bottom to top:
an ultra large pore MXene membrane layer with a thickness of 0-30 nanometers (nm) and a pore size of 2-5 nm;
a large pore MXene membrane layer with a thickness of 0-30 nm and a pore size of 0.9-1.2 nm;
a medium pore MXene membrane layer with a thickness of 20-50 nm and a pore size of 0.6-0.8 nm; and
a small pore MXene membrane layer with a thickness of 40-60 nm and a pore size of 0.3-0.5 nm;
where the overall thickness of the MXene membrane layers is 100 nm.

In an embodiment, the ultra large pore MXene membrane layer and the large pore MXene membrane layer may be omitted.

In an embodiment, the solvent for the MXene nanosheet dispersion is ethanol and water, with a volume ratio of ethanol to water being (0.5-1):1.

The aforementioned MXene membrane with gradient pores disclosed in the embodiments of the present disclosure may be applied in the field of gas separation; where the gas separation is hydrogen (H₂)/carbon dioxide (CO₂) gas separation.

All raw materials used in the present disclosure are purchased from the market.

The technical schemes of the present disclosure are further illustrated below through embodiments.

### Embodiment 1 (Three Layers)

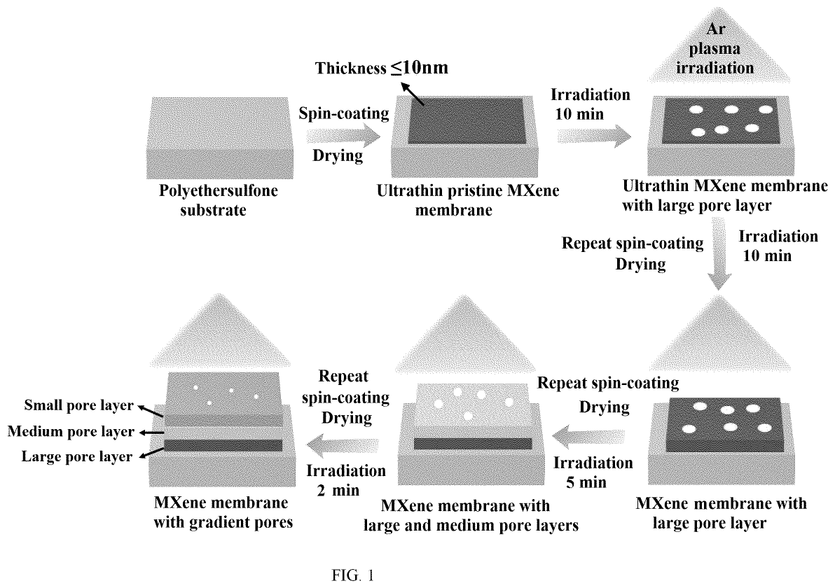

As shown in FIG. 1, a preparation method for a MXene membrane with gradient pores includes the following steps:
(1) preparing an aqueous and ethanol dispersion of pristine MXene (Ti₃C₂Tₓ) nanosheets: 2.5 grams (g) of lithium fluoride and 2 g of titanium aluminum carbide (Ti₃AlC₂) powder are mixed with 50 milliliters (mL) of a 9 molar (M) hydrochloric acid solution, and stirred at 50 degrees Celsius (° C.) for 30 hours (h). The reacted mixture slurry is repeatedly centrifugally washed at 3500-6000 revolutions per minute (rpm) until the pH is about 6. Finally, the solution is centrifuged at 5000 rpm for 30 min, and the supernatant is discarded to remove small flakes. The precipitate is centrifuged at 1500 rpm to collect the supernatant, which is the pristine Ti₃C₂Tₓ nanosheet aqueous dispersion. An equal volume of ethanol is mixed therewith to obtain the pristine MXene (Ti₃C₂Tₓ) nanosheet aqueous and ethanol dispersion;
(2) a 0.5 milligram per milliliter (mg/mL) MXene nanosheet dispersion is spin-coated onto a polyethersulfone substrate (pore size: 0.2 micrometer (μm)) to obtain an ultra-thin pristine MXene membrane (thickness: 10 nm), then it is placed under vacuum drying at 100° C. for 30 min, followed by Ar plasma irradiation for 10 min (irradiation power: 100 Watt (W); gas flow rate: 100 milliliters per minute (mL/min)). The above spin-coating and irradiation steps are repeated 3 times to obtain a MXene membrane with a large pore layer (thickness: 30 nm; pore size: 1.2 nm);
(3) the spin-coating and irradiation steps are repeated 3 times on the 30 nm thick MXene membrane with the large pore layer (with the irradiation time changed to 5 min, other conditions being the same as in step (2)) to obtain a MXene membrane with a large pore layer (thickness: 30 nm) and a medium pore layer (thickness: 30 nm, pore size: 0.6 nm); and
(4) on the basis of (3), the spin-coating and irradiation steps are continued and repeated 4 times (with the irradiation time changed to 2 min, other conditions being the same as in step (2)) to obtain a MXene membrane with a large pore layer (thickness: 30 nm; pore size: 1.2 nm), a medium pore layer (thickness: 30 nm, pore size: 0.6 nm), and a small pore layer (thickness: 40 nm, pore size: 0.3 nm), i.e., the MXene membrane with three-layer gradient pores (total thickness: 100 nm).

### Embodiment 2 (Two Layers)

A preparation method for a MXene membrane with gradient pores, which differs from Embodiment 1 in that:
step (2) is omitted, and step (3) is directly performed after step (1);
in step (3), the spin-coating and irradiation steps are performed 5 times, resulting in a medium pore layer thickness of 50 nm and a pore size of 0.6 nm; and
in step (4), the spin-coating and irradiation steps are performed 5 times, resulting in a small pore layer thickness of 50 nm and a pore size of 0.3 nm; thereby obtaining a MXene membrane with two-layer gradient pores consisting only of a medium pore layer (thickness: 50 nm) and a small pore layer (thickness: 50 nm).

Other process steps and parameters are the same as in Embodiment 1.

### Embodiment 3 (Three Layers, with the Thickness Different from Embodiment 1)

A preparation method for a MXene membrane with gradient pores, which differs from Embodiment 1 in that:
in step (2), the spin-coating and irradiation steps are performed 1 time, resulting in a large pore layer thickness of 10 nm and a pore size of 1.2 nm;
in step (3), the spin-coating and irradiation steps are performed 3 times, resulting in a medium pore layer thickness of 30 nm and a pore size of 0.6 nm; and
in step (4), the spin-coating and irradiation steps are performed 6 times, resulting in a small pore layer thickness of 60 nm and a pore size of 0.3 nm; thereby obtaining a MXene membrane with a large pore layer (thickness: 10 nm), a medium pore layer (thickness: 30 nm), and a small pore layer (thickness: 60 nm).

Other process steps and parameters are the same as in Embodiment 1.

### Embodiment 4 (Four Layers)

A preparation method for a MXene membrane with gradient pores, including the following steps:
(1) preparing an aqueous and ethanol dispersion of pristine MXene (Ti₃C₂Tₓ) nanosheets: 2.5 g of lithium fluoride and 2 g of Ti₃AlC₂ powder are mixed with 50 mL of a 9 M hydrochloric acid solution, and stirred at 50° C. for 30 h. The reacted mixture slurry is repeatedly centrifugally washed at 3500-6000 revolutions per minute (rpm) until the pH is approximately 6. Finally, the solution is centrifuged at 5000 rpm for 30 min, and the supernatant is discarded to remove small flakes. The precipitate is centrifuged at 1500 rpm to collect the supernatant, which is the pristine Ti₃C₂Tₓ nanosheet aqueous dispersion. An equal volume of ethanol is mixed therewith to obtain the pristine MXene (Ti₃C₂Tₓ) nanosheet aqueous and ethanol dispersion;
(2) a 0.5 mg/mL MXene nanosheet dispersion is spin-coated onto a polyethersulfone substrate (pore size: 0.2 μm) to obtain an ultra-thin pristine MXene membrane (thickness: 10 nm), then it is placed under vacuum drying at 100° C. for 30 min, followed by Ar plasma irradiation for 15 min (irradiation power: 100 W; gas flow rate: 100 mL/min). The above spin-coating and irradiation steps are repeated 1 time to obtain a MXene membrane with an ultra large pore layer (thickness: 10 nm; pore size: 5 nm);
(3) the spin-coating and irradiation steps are repeated 1 time on the 10 nm thick MXene membrane with the ultra large pore layer (with the irradiation time changed to 10 min, other conditions being the same as in step (2)) to obtain a MXene membrane with an ultra large pore layer (thickness: 10 nm; pore size: 5 nm) and a large pore layer (thickness: 10 nm, pore size: 1.2 nm);
(4) the spin-coating and irradiation steps are repeated 2 times on the 20 nm thick MXene membrane with the ultra large pore layer (10 nm) and the large pore layer (10 nm) (with the irradiation time changed to 5 min, other conditions being the same as in step (2)) to obtain a MXene membrane with an ultra large pore layer (thickness: 10 nm, pore size: 5 nm), a large pore layer (thickness: 10 nm, pore size: 1.2 nm), and a medium pore layer (thickness: 20 nm, pore size: 0.6 nm); and
(5) on the basis of (4), the spin-coating and irradiation steps are continued and repeated 6 times (with the irradiation time changed to 2 min, other conditions being the same as in step (2)) to obtain a MXene membrane with an ultra large pore layer (thickness: 10 nm), a large pore layer (thickness: 10 nm), a medium pore layer (thickness: 20 nm), and a small pore layer (thickness: 60 nm, pore size: 0.3 nm), i.e., the MXene membrane with four-layer gradient pores (total thickness: 100 nm).

### Comparative Example 1 (Single MXene Membrane)

A preparation method for a pristine MXene membrane, including the following steps:
(1) preparing an aqueous and ethanol dispersion of pristine MXene (Ti₃C₂Tₓ) nanosheets (specific preparation conditions are the same as in Embodiment 1); and
(2) a 0.5 mg/mL MXene nanosheet dispersion is spin-coated onto a polyethersulfone substrate (pore size: 0.2 μm) to obtain an ultra-thin pristine MXene membrane (thickness: 10 nm), then it is placed under vacuum drying at 100° C. for 30 min. The above spin-coating step is repeated 10 times to obtain a pristine MXene membrane with a thickness of 100 nm.

### Comparative Example 2 (Single-Layer, MXene Membrane with Only Small Pores)

A MXene membrane with only a small pore layer and its preparation method, including the following steps:
(1) preparing an aqueous and ethanol dispersion of pristine MXene (Ti₃C₂Tₓ) nanosheets (specific preparation conditions are the same as in Embodiment 1); and
(2) a 0.5 mg/mL MXene nanosheet dispersion is spin-coated onto a polyethersulfone substrate (pore size: 0.2 μm) to obtain an ultra-thin pristine MXene membrane (thickness: 10 nm), followed by Ar plasma irradiation for 2 min (irradiation power: 100 W; gas flow rate: 100 mL/min). The above spin-coating and irradiation steps are repeated 10 times to obtain a MXene membrane with only a small pore layer (thickness: 100 nm, pore size: 0.3 nm).

### Comparative Example 3 (Single-Layer, MXene Membrane with Only Medium Pores)

A MXene membrane with only a medium pore layer and its preparation method, which differs from Comparative Example 2 in that:
only the single plasma irradiation time is changed to 5 min, to obtain a MXene membrane with only a medium pore layer (thickness: 100 nm, pore size: 0.6 nm). Other process steps and parameters are the same as in Comparative Example 2.

### Comparative Example 4 (Single-Layer, MXene Membrane with Only Large Pores)

A MXene membrane with only a small pore layer and its preparation method, which differs from Comparative Example 2 in that:
only the single plasma irradiation time is changed to 10 min, to obtain a MXene membrane with only a large pore layer (thickness: 100 nm, pore size: 1.2 nm). Other process steps and parameters are the same as in Comparative Example 2.

### Comparative Example 5

A preparation method for a MXene membrane with gradient pores, which differs from Embodiment 1 in that:
an additional step is added between steps (1) and (2): Ar plasma irradiation for 15 min, with the spin-coating and irradiation steps performed 2 times; resulting in an ultra large pore layer thickness of 20 nm, where the pore size of the ultra large pores is 5 nm;
in step (2), the spin-coating and irradiation steps are performed 2 times, resulting in a large pore layer thickness of 20 nm and a large pore size of 1.2 nm;
in step (3), the spin-coating and irradiation steps are performed 3 times, resulting in a medium pore layer thickness of 30 nm and a medium pore size of 0.6 nm; and
in step (4), the spin-coating and irradiation steps are performed 3 times, resulting in a small pore layer thickness of 30 nm and a small pore size of 0.3 nm;
thereby obtaining a MXene membrane with an ultra large pore layer (thickness: 20 nm), a large pore layer (thickness: 20 nm), a medium pore layer (thickness: 30 nm), and a small pore layer (thickness: 30 nm).

Other process steps and parameters are the same as in Embodiment 1.

### Comparative Example 6

A MXene membrane with gradient pores and its preparation method, which differs from Embodiment 1 in that:
in step (2), the spin-coating and irradiation steps are performed 5 times, resulting in a large pore layer thickness of 50 nm and a large pore size of 1.2 nm;
in step (3), the spin-coating and irradiation steps are performed 3 times, resulting in a medium pore layer thickness of 30 nm and a medium pore size of 0.6 nm; and
in step (4), the spin-coating and irradiation steps are performed 2 times, resulting in a small pore layer thickness of 20 nm and a small pore size of 0.3 nm; thereby obtaining a MXene membrane with a large pore layer (thickness: 50 nm), a medium pore layer (thickness: 30 nm), and a small pore layer (thickness: 20 nm).

Other process steps and parameters are the same as in Embodiment 1.

### Effect Verification

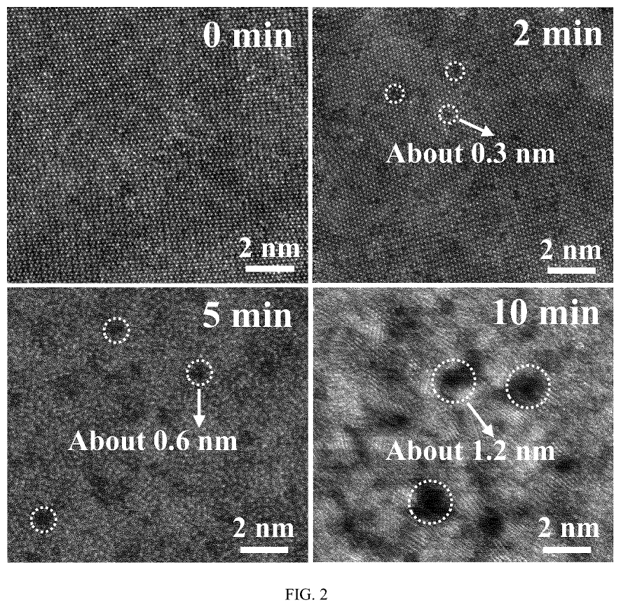

The present disclosure verifies the change in the in-plane pore size of MXene nanosheets under different Ar plasma irradiation times during the preparation process of Embodiment 1 using spherical aberration transmission electron microscopy. As may be observed from FIG. 2, as the plasma irradiation time increases from 2 min to 10 min, the pore size of the MXene nanosheets gradually increases from 0.3 nm to 1.2 nm. Subsequently, the MXene membranes prepared in the embodiments and comparative examples are placed in a gas separation device. An equal-volume mixture of H₂/CO₂ (flow rate: 50 mL/min each) is introduced into the feed side, argon gas (flow rate: 50 mL/min) is introduced into the sweep side, and the gas from the permeate side is introduced into a gas chromatograph for detection.

Firstly, the gas separation performance of the pristine MXene membrane (Comparative Example 1), the MXene membranes with single-layer pores (Comparative Example 2, Comparative Example 3 and Comparative Example 4), and the MXene membrane with gradient pores (Embodiment 1) are compared, as shown in Table 1:

TABLE 1

| Separation | Comparative | Comparative | Comparative | Comparative | Embodiment |
|---|---|---|---|---|---|
| performance | Example 1 | Example 2 | Example 3 | Example 4 | 1 |
| H₂ | 320 | 599 | 1258 | 2158 | 1564 |
| permeation | | | | | |
| rate/GPU | | | | | |
| H₂/CO₂ | 184 | 181 | 122 | 54 | 164 |
| selectivity | | | | | |

According to Table 1, it is found that as the irradiation time increases, the H₂ permeation rate gradually increases, and the H₂/CO₂ selectivity gradually decreases. This indicates that neither the pristine MXene membrane nor the MXene membranes with single-layer pores may achieve both high H₂ permeation rate and high H₂/CO₂ selectivity simultaneously. However, in contrast, the MXene membrane with gradient pores prepared in Embodiment 1 shows an H₂ permeation rate increased by nearly 5 times (from 320 GPU to 1564 GPU) compared to the pristine MXene membrane, while the selectivity is substantially maintained (from 184 to 164). The large pore layer (pore size: 1.2 nm) of this membrane may modify the polyethersulfone substrate with micrometer-sized pores, serving as a support layer, effectively avoiding the problem of increased defects in the MXene membrane caused by overly large substrate pores. Meanwhile, due to the relatively large pore size of the large pore layer, it also contributes to the permeability of the membrane. Furthermore, the abundant vertical multi-Ångström channels and interlayer channels in the medium pore layer (pore size: 0.6 nm) and the small pore layer (pore size: 0.3 nm) endow the MXene membrane with an ultra-high H₂ permeation rate and excellent H₂/CO₂ selectivity.

Secondly, the present disclosure also investigated the influence of the number of layers (Embodiment 1, Embodiment 2, and Comparative Example 5) and the thickness of each layer (Embodiment 1, Embodiment 3, and Comparative Example 6) of the MXene membrane with gradient pores on the H₂/CO₂ gas separation performance, as shown in Table 2:

TABLE 2

| Separation | Embodiment | Embodiment | Embodiment | Embodiment | Comparative | Comparative |
|---|---|---|---|---|---|---|
| performance | 1 | 2 | 3 | 4 | Example 5 | Example 6 |
| H₂ | 1564 | 984 | 1067 | 1537 | 2017 | 2124 |
| permeation | | | | | | |
| rate/ GPU | | | | | | |
| H₂/CO₂ | 164 | 165 | 171 | 161 | 62 | 71 |
| selectivity | | | | | | |

From Table 2, it may be found that when the MXene membrane with gradient pores has 3 layers, with the thickness and irradiation time for each layer from top to bottom being 40 nm/2 min, 30 nm/5 min, and 30 nm/10 min, respectively (i.e., Embodiment 1), it exhibits the optimal H₂/CO₂ separation performance.

The above are only optional specific embodiments of the present disclosure, but the protection scope of the present disclosure is not limited thereto. Any changes or substitutions readily conceivable by any person skilled in the art within the technical scope disclosed in the present disclosure is required to be considered encompassed within the protection scope of the present disclosure. Therefore, the protection scope of the present disclosure is required to subject to the protection scope defined by the claims.

What is claimed is:

1. A MXene membrane with gradient pores, wherein excluding a substrate, the MXene membrane with gradient pores comprises following layers in sequence from bottom to top:
an ultra large pore MXene membrane layer with a thickness of 0-30 nanometers (nm) and a pore size of 2-5 nm;
a large pore MXene membrane layer with a thickness of 0-30 nm and a pore size of 0.9-1.2 nm;
a medium pore MXene membrane layer with a thickness of 20-50 nm and a pore size of 0.6-0.8 nm; and
a small pore MXene membrane layer with a thickness of 40-60 nm and a pore size of 0.3-0.5 nm;
wherein an overall thickness of the MXene membrane layers is 100 nm.

2. The MXene membrane with gradient pores according to claim 1, wherein excluding the substrate, the MXene membrane with gradient pores comprises the following layers in sequence from bottom to top:
a large pore MXene membrane layer with a thickness of 30 nm and a pore size of 0.9-1.2 nm;
a medium pore MXene membrane layer with a thickness of 30 nm and a pore size of 0.6-0.8 nm; and
a small pore MXene membrane layer with a thickness of 40 nm and a pore size of 0.3-0.5 nm.

3. The MXene membrane with gradient pores according to claim 1, wherein excluding the substrate, the MXene membrane with gradient pores comprises the following layers in sequence from bottom to top:
a large pore MXene membrane layer with a thickness of 10 nm and a pore size of 0.9-1.2 nm;
a medium pore MXene membrane layer with a thickness of 30 nm and a pore size of 0.6-0.8 nm; and
a small pore MXene membrane layer with a thickness of 60 nm and a pore size of 0.3-0.5 nm.

4. The MXene membrane with gradient pores according to claim 1, wherein excluding the substrate, the MXene membrane with gradient pores comprises the following layers in sequence from bottom to top:
a medium pore MXene membrane layer with a thickness of 50 nm and a pore size of 0.6-0.8 nm; and
a small pore MXene membrane layer with a thickness of 50 nm and a pore size of 0.3-0.5 nm.

5. A preparation method for a MXene membrane with gradient pores, comprising following steps:
spin-coating MXene nanosheet dispersion onto a substrate, drying, followed by plasma irradiation, and repeating above operation, wherein the MXene membrane with gradient pores according to claim 1 is obtained by controlling plasma irradiation time.

6. The preparation method for the MXene membrane with gradient pores according to claim 5, wherein a concentration of MXene nanosheets in the MXene nanosheet dispersion is 0.5 milligram per milliliter (mg/mL).

7. The preparation method for the MXene membrane with gradient pores according to claim 5, wherein a drying process is: vacuum drying at 100 degrees Celsius (C) for 30 minutes (min).

8. The preparation method for the MXene membrane with gradient pores according to claim 5, wherein conditions during the plasma irradiation are:
an irradiation power of 100 Watt (W); a gas flow rate of 100 milliliters per minute (mL/min);
and an irradiation time of 2-15 min.

9. The preparation method for the MXene membrane with gradient pores according to claim 8, wherein:
when the irradiation time is 11-15 min, an ultra large pore MXene membrane layer is formed;
when the irradiation time is 6-10 min, a large pore MXene membrane layer is formed;
when the irradiation time is 3-5 min, a medium pore MXene membrane layer is formed; and
when the irradiation time is 1-2 min, a small pore MXene membrane layer is formed.
